(19) United States
(12) Patent Application Publication
(10) Pub. No.: US 2009/0172396 A1
(43) Pub. Date: Jul. 2, 2009

(54) SECURE INPUT

(75) Inventors: Douglas Gabel, Hillsboro, OR (US); Moshe Maor, Haifa (IL)

Correspondence Address: INTEL CORPORATION;c/o CPA Global, P.O. BOX 52050, MINNEAPOLIS, MN, 55402, US

(73) Assignee: INTEL CORPORATION, Santa Clara, CA (US)

(21) Appl. No.: 11/967,988

(22) Filed: Dec. 31, 2007

(51) Int. Cl. H04L 9/32

(52) U.S. Cl. 713/168

(57) ABSTRACT

In some embodiments input information received at an input device is encrypted before it is sent to a computer to be coupled to the input device. Other embodiments are described and claimed.

### RELATED APPLICATIONS

This application is related to the following applications filed on the same date as this application:
“Personal Guard” to Moshe Maor, Attorney Docket Number P25461;
“Management Engine Secured Input” to Moshe Maor, Attorney Docket Number P25460;
“Personal Vault” to Moshe Maor, Attorney Docket Number P26881;
“Secure Client/Server Transactions” to Moshe Maor, Attorney Docket Number P26890.

### TECHNICAL FIELD

The inventions generally relate to secure input.

### BACKGROUND

Many different types of keyloggers currently exist to allow hackers to hook into different layers in the software stack of a user's computer. The hooking point can be as low (that is, as close to the hardware) as a keyboard base driver or as high (that is, as far from the hardware) as a script that runs inside the scope of an internet browser. In this manner, software based keyloggers and other types of malware may be used by a hacker to hijack sensitive information that a user types into a computer. Therefore, a need has arisen to protect a user's sensitive information from a hacker using keyloggers and other types of malware.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a system according to some embodiments of the inventions.

### DETAILED DESCRIPTION

Some embodiments of the inventions relate to secure input.

In some embodiments input information received at an input device is encrypted before it is sent to a computer to be coupled to the input device.

In some embodiments an input device is to receive input information and an input device controller is coupled to the input device. The input device controller is to encrypt the input information before it is sent to a computer to be coupled to the input device.

In some embodiments a computer, an input device, and an input device controller is included. The input device is to receive input information and the input device controller is coupled to the input device. The input device controller is to encrypt the input information before it is sent to the computer.

In some embodiments an article includes a computer readable medium (for example, a tangible medium) having instructions thereon which when executed cause a computer to receive input information at an input device, and to encrypt the received input information before it is sent to a computer to be coupled to the input device.

In some embodiments a web site where sensitive information is exchanged or entered is interfaced with, a plug-in is received from the web site, the web site is verified as being trusted in response to the plug-in, input information input on an input device is encrypted before it is sent to a computer to be coupled to the input device, and the encrypted input information is sent to the web site.

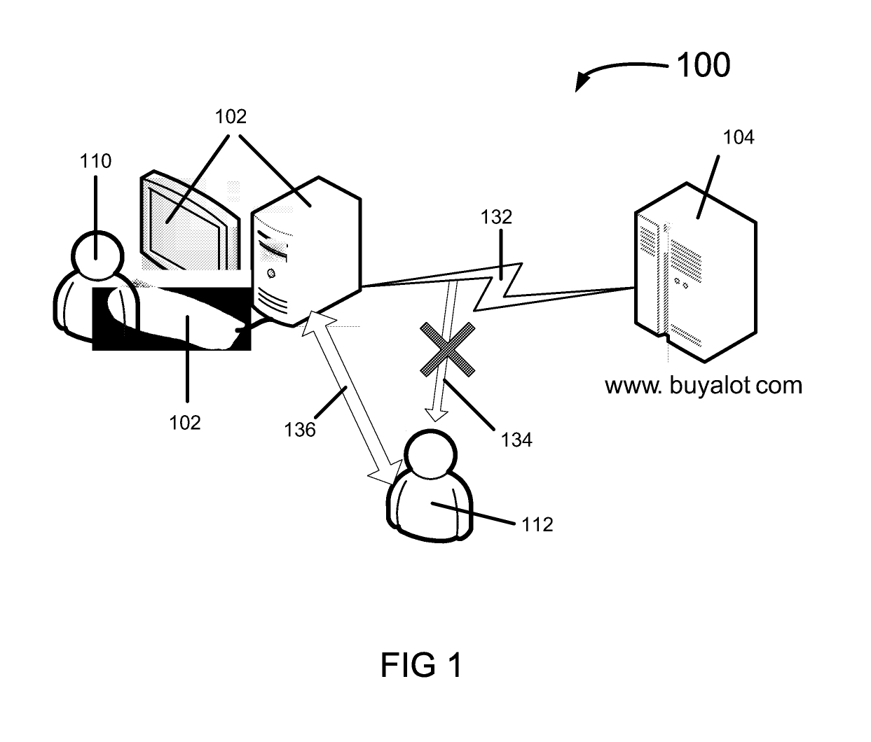

FIG. 1 illustrates a system 100 according to some embodiments. In some embodiments system 100 includes a computer 102 and a remote server 104. FIG. 1 illustrates how an end user 110 (for example, an on-line purchaser of goods and/or services) that is doing some on-line shopping using the computer 102 that is connected to the remote server 104 (for example, via the internet) may be open to attacks from a hacker 112. In the on-line shopping example, a common scenario might include the following numbered steps:

1. The end user 110 is using an internet browser loaded on computer 102 to surf in an e-commerce web site to choose good for purchase (for example, via a remote server 104 of a “www.buyalot.com” web site)
2. The user 110 picks some goods from the “www.buyalot.com” web site and places them into a virtual basket
3. At some point when the user 110 has finished choosing goods for purchase, the user hits a checkout button
4. The e-commerce server 104 opens a form in a window for the user 110 and asks for the user to enter payment information in the form
5. The user 110 types sensitive data into fields of the form such as, for example, a credit card number, phone number, full name, address, etc.
6. The e-commerce server 104 sends back a receipt to the user

During the most sensitive portions of the exemplary scenario discussed above (for example, during steps 4 and 5), the communication between the internet browser of the user 110 and the server 104 of the remote site is typically run on top of a secured connection 132 such as a secure socket layer (SSL) and/or a transfer layer security (TLS), for example. This precludes any adversary such as hacker 112 on the internet that wishes to capture the sensitive data entered by the user from obtaining that data without first breaking cryptographic algorithms used by the secured connected (that is, SSL and/or TLS cryptographic algorithms). This is not typically a problem due to a very high computation complexity that would be required by the hacker 112. Arrow 134 illustrates an attempt by hacker 112 to obtain information via this method. An “X” is included over arrow 134 to illustrate the extreme difficulties in attempting this type of theft attempt.

The typical user 110 is normally aware of the fact that some protection is necessary in order to avoid theft of personal information entered in such a scenario. For example, most users know to look for a special icon normally displayed on a control line of the internet browser that indicates that the current session is being executed over a secured connection. However, a sophisticated hacker 112 may attempt to steal the sensitive information using a completely different approach that is not protected by using a secured connection 132 such as SSL or TLS. For example, in some embodiments, hacker 112 may use a keylogger or other malware to obtain the sensitive information, as illustrated via arrow 136 in FIG. 1. Many different types of keyloggers and/or other malware are currently available, and have the ability to hook into different layers in the software stack running on computer 102, for example. The hooking point for the keyloggers and/or malware can be as low (that is, closer to the hardware) as a keyboard base driver or as high (that is, further from the hardware) as a script that runs inside the scope of the internet browser running on computer 102, for example. Therefore, while it is very important to mitigate network theft attacks on the sensitive data, it is not enough to entirely mitigate theft attacks of sensitive data (resulting, for example, in identity theft).

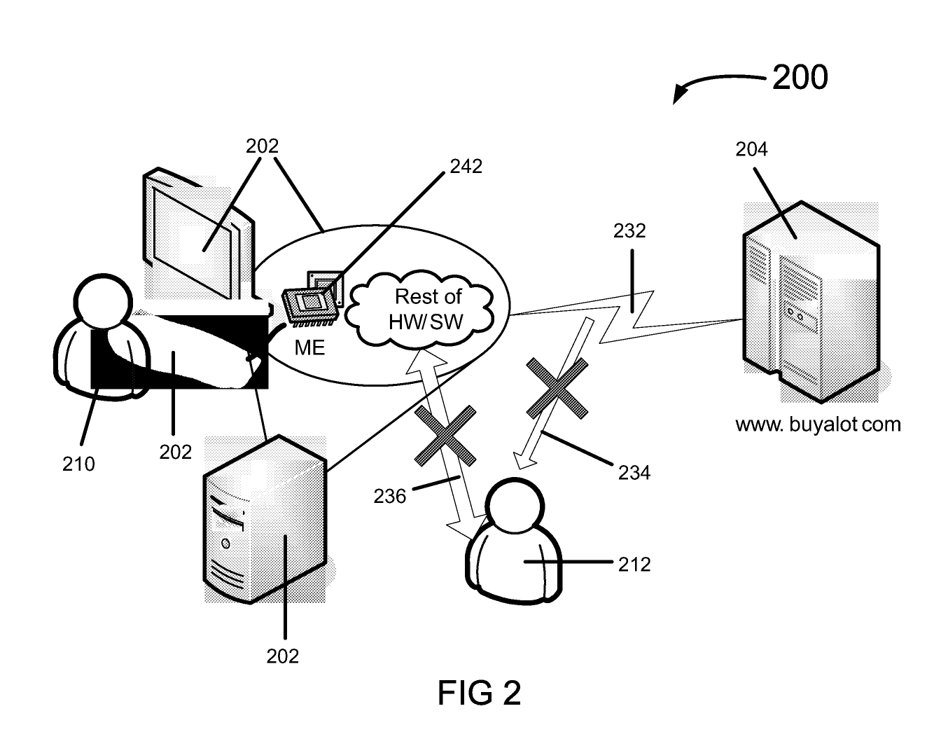

FIG. 2 illustrates a system 200 according to some embodiments. In some embodiments system 200 includes a computer 202 and a remote server 204. FIG. 2 illustrates how an end user 210 (for example, an on-line purchaser of goods and/or services) that is doing some on-line shopping using the computer 202 that is connected to the remote server 204 (for example, via the internet) may guard from attacks from a hacker 212. Similar to the arrangement described in reference to FIG. 1, the communication between the internet browser of the user's computer 202 and the server 204 of the remote site is typically run on top of a secured connection 232 such as a secure socket layer (SSL) and/or a transfer layer security (TLS), for example. This precludes any adversary such as hacker 212 on the internet that wishes to capture the sensitive data entered by the user from obtaining that data without first breaking cryptographic algorithms used by the secured connected (that is, SSL and/or TLS cryptographic algorithms).

Computer 202 includes a management engine (and/or manageability engine and/or ME). In some embodiments, ME 242 is a micro-controller and/or an embedded controller. In some embodiments, ME 242 is included in a chipset of computer 202. In some embodiments, ME 242 is included in a Memory Controller Hub (MCH) of computer 202. In some embodiments, ME 242 is included in a Graphics and Memory Controller Hub of computer 202.

In some embodiments, ME 242 may be implemented using an embedded controller that is a silicon-resident management mechanism for remote discovery, healing, and protection of computer systems. In some embodiments, this controller is used to provide the basis for software solutions to address key manageability issues, improving the efficiency of remote management and asset inventory functionality in third-party management software, safeguarding functionality of critical agents from operating system (OS) failure, power loss, and intentional or inadvertent client removal, for example. In some embodiments, infrastructure supports the creation of setup and configuration interfaces for management applications, as well as network, security, and storage administration. The platform provides encryption support by means of Transport Layer Security (TLS), as well as robust authentication support.

In some embodiments the ME is hardware architecture resident in firmware. A micro-controller within a chipset graphics and memory controller hubs houses Management Engine (ME) firmware, which implements various services on behalf of management applications. Locally, the ME can monitor activity such as the heartbeat of a local management agent and automatically take remediation action. Remotely, the external systems can communicate with the ME hardware to perform diagnosis and recovery actions such as installing, loading or restarting agents, diagnostic programs, drivers, and even operating systems.

Personal guard technology included in system 200 can be used to completely mitigate any attempted attacks from keyloggers and other types of malware. In some embodiments, management engine (and/or manageability engine and/or ME) 242 included within computer 202 takes control over the keyboard of the computer 202 and sets up a trusted path between the user 210 and the ME 242 via any input devices of computer 202 such as the keyboard. Additionally, the ME 242 sets up a secured path (although not a direct connection) between the ME 242 and the remote server 204.

When funneling the sensitive data via the ME 242, the ME 242 actually encrypts the sensitive data that the user 210 types, for example, before the software running on computer 202 obtains the data (for example, sensitive data such as credit card numbers, phone numbers, full name, addresses, etc.) In this manner, when the software that runs on the host processor, for example, of computer 202 is handling the data it is already encrypted and is therefore not usable for keyloggers in an attempt to steal the data via arrow 236 by the hacker 212. Therefore, no matter what type of keylooger is able to infiltrate computer 202 and is currently running on the host processor of computer 202 as part of the software stack, the sensitive data of the user 210 is kept secret when personal guard operations (for example, via ME 242) are being used while user 210 is typing the data.

FIG. 2 has described using personal guard operations to mitigate hacker attempts such as keyloggers from stealing sensitive data entered by a user. However, it is recognized that a management engine such as ME 242 of FIG. 2 is not necessary for all embodiments, and that other devices may be used to implement the same types of operations as described herein. Additionally, an Intel branded ME and/or Intel AMT is not necessary for all embodiments, and other devices may be used to implement the same types of operations as described herein.

In some embodiments a software and/or Operating System (OS) agent is prevented from “sniffing” of input device activity (for example, of keyboard activity). As described above, rogue software agents can monitor keyboard activity for interesting items such as credit card accounts, user names, passwords, etc. Once this data is gathered, criminal activity can be initiated with somewhat obvious results. In some embodiments, such rogue software agents are prevented from getting the critical information. FIG. 1 and FIG. 2 and the above description help to understand a personal guard technology that may be used to provide a guard that prevents, for example, rogue software agents from getting the critical information. This personal guard technology is described in more detail in a U.S. patent application filed on the same date as this application entitled “Personal Guard” to Moshe Maor, Attorney Docket Number P25461. The technology described in that application includes reliance on the ME in the chipset (for example, in the ICH and/or PCH) to intercept keystrokes from the keyboard, and encrypts the information before sending it to the requested web site.

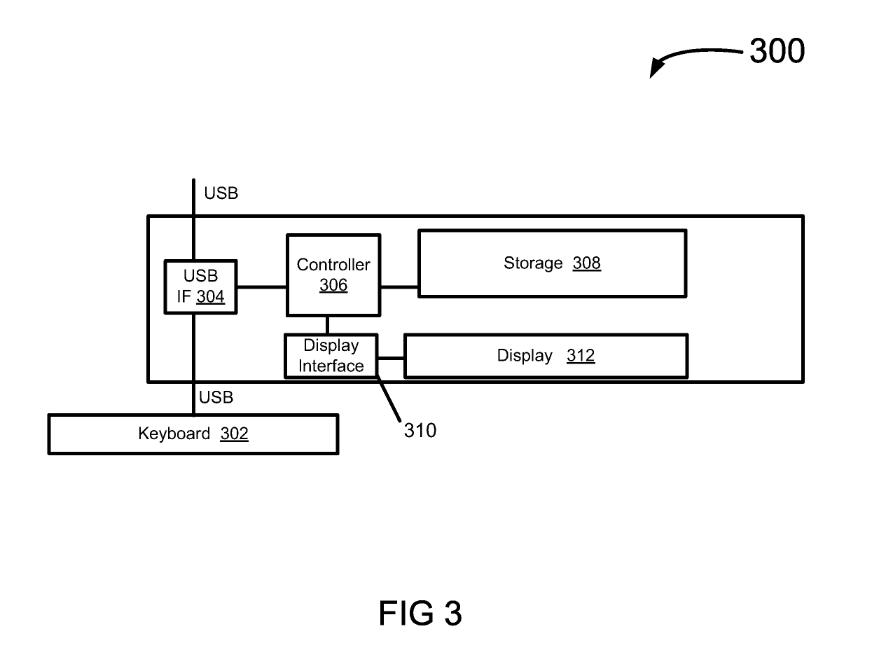

FIG. 3 illustrates a system 300 according to some embodiments. System 300 includes a keyboard 302 (for example, a USB keyboard), an interface 304 (for example, a USB interface), a controller 306 (for example, a microprocessor), storage 308, a display interface 310, and a display 312. System 300 is a standalone implementation in which hardware support such as interface 304, controller 306, storage 308, display interface 310, and/or display 312 are built into an external device (for example, an external USB device). The interface 304 handles the interface physical layer (for example, the USB interface physical level). The controller 306 makes all decisions and performs encryption. Storage 308 is used to store non-volatile code (for example, firmware) and to provide temporary run-time storage. In some embodiments storage 308 includes flash memory and/or SRAM. The display interface 310 and the display 312 show prompts and provide feedback on entered keystrokes. In some embodiments, depending on the data type being entered, the keystrokes are shown to the user on the display 312, and/or are hidden from view (passwords, for example, are typically hidden, for example, using “***********”).

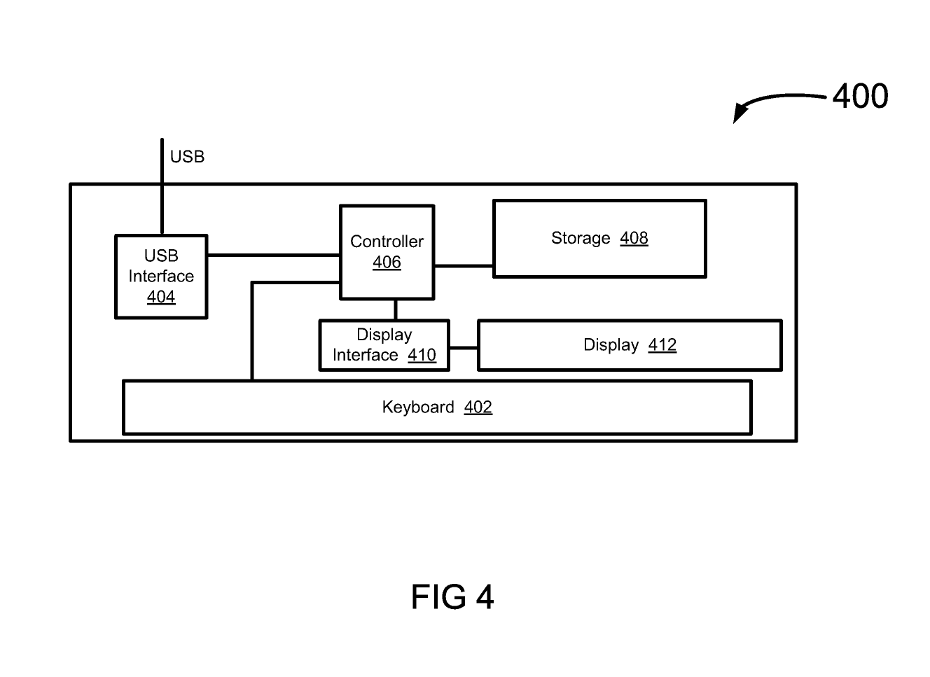

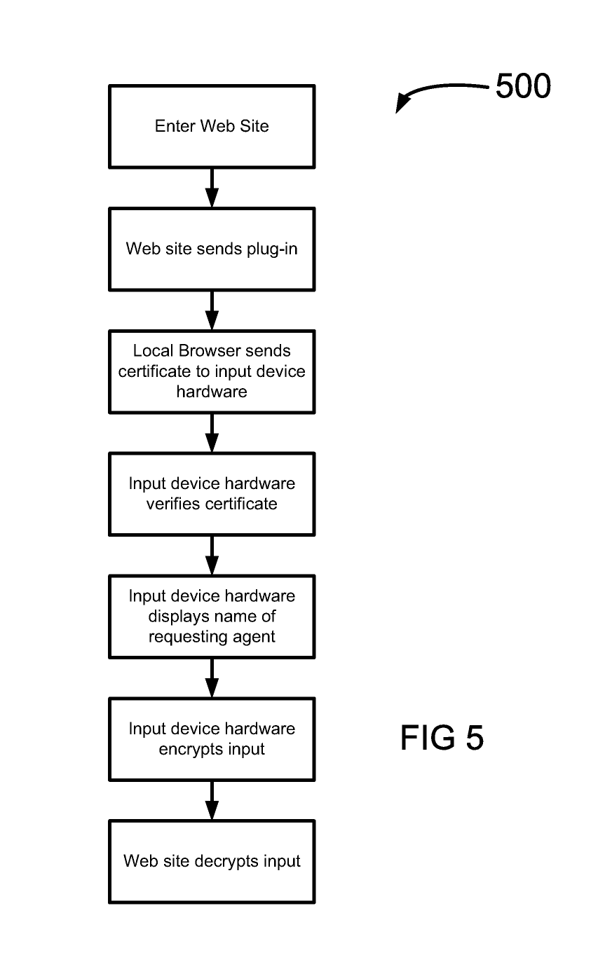

FIG. 4 illustrates a system 400 according to some embodiments. System 400 includes a keyboard 402 (for example, a USB keyboard), an interface 404 (for example, a USB interface), a controller 406 (for example, a microprocessor), storage 408, a display interface 410, and a display 412. System 400 is an integrated implementation in which hardware support such as interface 404, controller 406, storage 408, display interface 410, and/or display 412 are integrated into the keyboard 402. The interface 404 handles the interface physical layer (for example, the USB interface physical level). The controller 406 makes all decisions and performs encryption. Storage 408 is used to store non-volatile code (for example, firmware) and to provide temporary run-time storage. In some embodiments storage 408 includes flash memory and/or SRAM. The display interface 410 and the display 412 show prompts and provide feedback on entered keystrokes. In some embodiments, depending on the data type being entered, the keystrokes are shown to the user on the display 412, and/or are hidden from view (passwords, for example, are typically hidden, for example, using “***********”).

FIG. 5 illustrates a flow 500 according to some embodiments. In some embodiments, flow 500 illustrates how data may be protected using personal guard. In some embodiments, a portion of flow 500 may be implemented using, for example, controller 306 and/or controller 406. At 502 a web site is entered where sensitive data is exchanged or entered. At 504 the web site sends a plug-in (for example, a personal guard plug-in) to a personal guard enabled computer platform. At 506 the personal plug-in on the local browser sends a personal guard certificate, public key, and current Certificate Revocation List (CRL) to the personal guard hardware (for example, to the hardware of system 300 or system 400 and/or to the controller 306 or controller 406). In addition to the personal guard certificate, information may be sent to the personal guard hardware relating to who is requesting the information, what kind of data is being requested (for example, password, account number, etc.), and text to show to the end user for prompting. At 508 the personal guard hardware (for example, controller) verifies the certificate (in some embodiments assuming prior provisioning with a root certificate) and makes sure that the certificate has not been revoked. At 510 the personal guard hardware (and/or controller) displays the name of the requesting agent and a text prompt for a private display. At 512 input (for example, keystrokes) are encrypted using the public key and sent back to the browser to be forwarded to the requesting web site. At 514 the web site decrypts the keystrokes using their private key.

In some embodiments all inputs on an input device (for example, keystrokes input on a keyboard) are encrypted and/or scrambled. In some embodiments certain inputs on an input device (for example, certain keystrokes input on a keyboard) are encrypted and/or scrambled (for example, only certain information such as passwords, account numbers, etc.)

Although the inventions have been described herein in reference to keyboards, and specifically to USB keyboards, it is noted that some embodiments may be implemented in reference to other types of input devices than keyboards, or to other keyboard devices that are not USB keyboards such as PS/2 keyboards, for example.

In some embodiments an input device (for example, a keyboard) is able to encrypt data (for example, via an integrated keyboard solution or via a standalone external implementation (for example, an external USB device). In some embodiments this encryption prevents, for example, OS agents or any other rogue agents from detecting and capturing input information (for example, all keystrokes). In some embodiments “anti-phishing” is provided by verifying that the web site or server has a valid certificate that is issued by a trusted root certificate. In some embodiments a strong warning may be displayed against sending confidential information to un-trusted servers. In some embodiments the invention is applicable for any type of secure input requirements where verified input must be coming from an input device such as a keyboard and the contents need to be protected. In some embodiments a remote login such as VPN (Virtual Private Network) may be implemented. In some embodiments a user can bring their own keyboard to a public computer (for example, at an internet café) in order to ensure secure input.

Although some embodiments have been described herein as being implemented in a particular manner, according to some embodiments these particular implementations may not be required. For example, although some embodiments have been described as using an ME, other embodiments do not require use of an ME.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
an input device to receive input information; and
an input device controller coupled to the input device, the input device controller to encrypt the input information before it is sent to a computer to be coupled to the input device.

2. The apparatus of claim 1, wherein the input device controller is integrated in the input device.

3. The apparatus of claim 1, wherein the input device controller is in an external device coupled between the input device and the computer to be coupled to the input device.

4. The apparatus of claim 1, wherein the controller is further to verify a recipient of the input information.

5. The apparatus of claim 4, wherein the recipient of the input information is a web site.

6. The apparatus of claim 1, wherein the input information includes a password or an account number.

7. A system comprising:
a computer;
an input device to receive input information to be provided to the computer; and
an input device controller coupled to the input device, the input device controller to encrypt the input information before it is sent to the computer.

8. The system of claim 7, wherein the input device controller is integrated in the input device.

9. The system of claim 7, wherein the input device controller is in an external device coupled between the input device and the computer.

10. The system of claim 7, wherein the controller is further to verify a recipient of the input information.

11. The system of claim 10, wherein the recipient of the input information is a web site.

12. The system of claim 7, wherein the input information includes a password or an account number.

13. A method comprising:
receiving input information at an input device; and
encrypting the received input information before it is sent to a computer to be coupled to the input device.

14. The method of claim 13, further comprising verifying a recipient of the input information.

15. The method of claim 13, wherein the recipient of the input information is a web site.

16. The method of claim 13, wherein the input information includes a password or an account number.

17. An article comprising:
a computer readable medium having instructions thereon which when executed cause a computer to:
receive input information at an input device; and
encrypt the received input information before it is sent to a computer to be coupled to the input device.

18. The article of claim 17, the computer readable medium further having instructions thereon which when executed cause a computer to verify a recipient of the input information.

19. The article of claim 17, wherein the recipient of the input information is a web site.

20. The article of claim 17, wherein the input information includes a password or an account number.

21. A method comprising:
interfacing with a web site where sensitive information is exchanged or entered;
receiving a plug-in from the web site;
verifying that the web site is trusted in response to the plug-in;
encrypting input information input on an input device before it is sent to a computer to be coupled to the input device; and
sending the encrypted input information to the web site.

22. The method of claim 21, wherein the input information includes a password or an account number.
